(19) United States
(12) Patent Application Publication
(10) Pub. No.: US 2008/0093817 A1
(43) Pub. Date: Apr. 24, 2008

(54) Crimp ring and stabilizer bar assembly

(75) Inventor: Jonathan Russell, Rochester Hills, MI (US)

Correspondence Address: CARLSON, GASKEY & OLDS, P.C., 400 WEST MAPLE ROAD, SUITE 350, BIRMINGHAM, MI, 48009, US

(73) Assignee: Meritor Suspension Systems Company, U.S.

(21) Appl. No.: 11/584,968

(22) Filed: Oct. 23, 2006

(51) Int. Cl. B60G 21/05; B23P 11/00

(52) U.S. Cl. 280/124.106; 280/124.166; 267/273; 29/516

(57) ABSTRACT

A stabilizer bar includes at least one bushing that is adapted for mounting to a vehicle structure. A crimp ring is secured to the stabilizer bar to prevent relative axial movement between the bushing and the stabilizer bar. The crimp ring initially has a horse-shoe or C-shape that allows the crimp ring to be easily slid onto the stabilizer bar right next to the bushing. The crimp ring is then deformed around the stabilizer bar to permanently secure the crimp ring to the stabilizer bar.

### TECHNICAL FIELD

A stabilizer bar includes an improved anti-walk feature that prevents relative axial movement between a stabilizer bar and an associated bushing.

### BACKGROUND OF THE INVENTION

A stabilizer bar is used in a vehicle suspension to improve stability and handling characteristics as a vehicle experiences suspension loading. The stabilizer bar extends in a lateral direction between opposed wheel ends and typically connects suspension elements mounted on an axle at one wheel end to suspension elements on the axle at an opposite wheel end. Bushings are used to mount a central portion of the stabilizer bar to a vehicle structure, such as a vehicle frame.

Under certain conditions, the stabilizer bar can move in an axial direction relative to these bushings. This is often referred to as “walking.” In the past, anti-walk features have been incorporated onto the stabilizer bar to prevent this phenomenon. Known anti-walk features are often difficult to assemble onto the stabilizer bar and/or require additional components or material processing, which undesirably increases cost.

Thus, there is a need for a more cost-effective anti-walk feature that overcomes the deficiencies discussed in the prior art above.

### SUMMARY OF THE INVENTION

A crimp ring is crimped onto a stabilizer bar adjacent to a bushing. The crimp ring prevents relative lateral movement between the bushing and the stabilizer bar, i.e. prevents “walking” from occurring.

In one example, the stabilizer bar defines a lateral axis, and the crimp ring is slid onto the stabilizer bar in a direction transverse to the lateral axis. The crimp ring is then crimped around an outer surface of the stabilizer bar to permanently attach the crimp ring to the stabilizer bar.

In one example, the crimp ring has an initial first shape when first installed on the stabilizer bar, and is subsequently deformed into a second shape during crimping. The first shape comprises a horse-shoe or C-shape, and the second shape comprises a generally circular shape.

The crimp ring provides a simple and inexpensive anti-walk feature that is easily installed on a stabilizer bar. These and other features of the present invention can be best understood from the following specification and drawings, the following of which is a brief description.

### BRIEF DESCRIPTION OF THE DRAWINGS

FIG. 1 is a schematic view of a vehicle suspension incorporating the subject invention.

FIG. 2 is a perspective view of a stabilizer bar, bushing, and crimp ring in a first assembly position.

FIG. 3 shows a second assembly position.

FIG. 4 shows a third assembly position.

### DETAILED DESCRIPTION OF THE PREFERRED EMBODIMENT

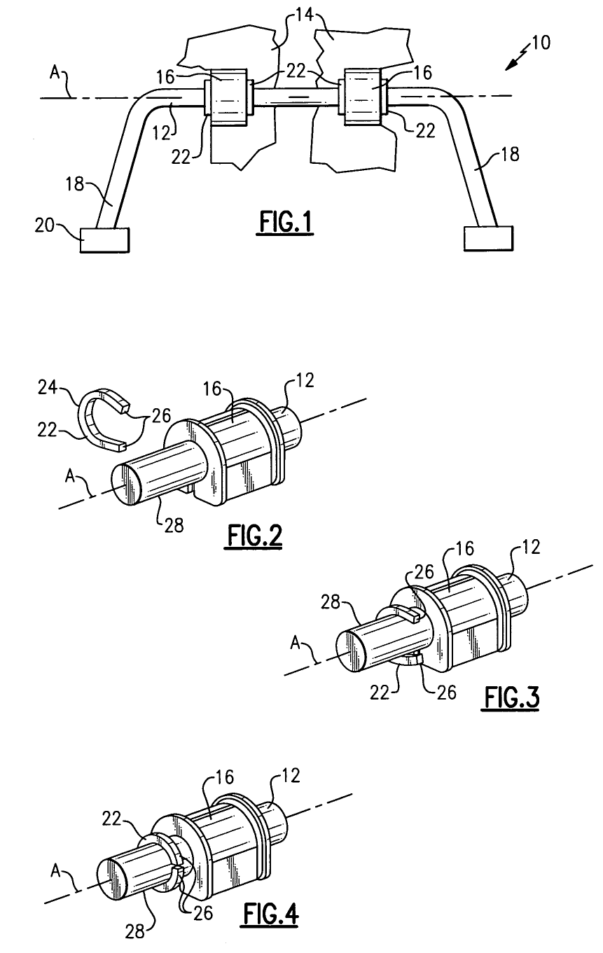

A suspension assembly 10, shown in FIG. 1, includes a stabilizer bar 12 that is securable to a vehicle structure 14 with bushings 16. Two bushings 16 are shown, however, a single bushing or a greater number of bushings could also be utilized for certain applications. The stabilizer bar 12 extends in a generally lateral direction along an axis A between laterally opposed vehicle wheels (not shown), and includes opposing ends 18 that are securable to laterally opposed suspension components 20, such as left hand and right hand control arms, for example. It should be understood that while the stabilizer bar 12 is generally shown to have a C-shape or U-shape configuration, the stabilizer bar 12 may include bends and/or angled portions depending upon the desired suspension configuration and vehicle application.

At least one crimp ring 22 is secured to the stabilizer bar 12 adjacent to one lateral side of each bushing 16. The bushings 16 are typically made from a resilient material such as rubber, for example; however, other types of materials could also be used. In one example, the crimp ring 22 is made from a steel material such as 1008-1010; however, other types of materials could also be used.

As shown, the crimp rings 22 could also be secured to the stabilizer bar 12 on both lateral sides of each bushing 16. The crimp ring 22 prevents relative lateral movement between the bushing 16 and the stabilizer bar 12 in a direction along the axis A, i.e. the crimp ring 22 prevents the phenomenon of “walking.”

The crimp ring 22 is assembled onto the stabilizer bar 12 in the following manner. The crimp ring 22 initially has a first shape, which comprises a horse-shoe shape, C-shape, or U-shape, for example, as shown in FIG. 2. In this initial first shape, the crimp ring has a central base portion 24 that extends to first and second distal ends 26 that are spaced apart from each other. Preferably, the first and second distal ends 26 are spaced apart from each other by an amount similar to a diameter of the stabilizer bar 12. This allows the crimp ring 22 to be easily slid onto the stabilizer bar 12 in a direction transverse to the axis A, and immediately adjacent to the bushing 16, see FIG. 3. However, the spacing might also allow the crimp ring 22 to be at least loosely retained on the stabilizer bar 12 such that the crimp ring 22 will not fall off prior to performance of a crimping step.

After the crimp ring 22 is slid onto the stabilizer bar 12, the crimp ring 22 is then plastically deformed by a crimping process into a second shape to permanently attach the crimp ring 22 to the stabilizer bar 12, see FIG. 4. Any type of crimping tool or process can be used to crimp the crimp ring 22.

During crimping, plastic deformation of the crimp ring occurs with the first and second distal ends 26 being moved toward each other such that the second shape comprises a generally circular shape. Once crimped, the crimp ring 22 substantially surrounds an exterior surface 28 of the stabilizer bar 12. The crimp ring 22 provides a simple anti-walk feature that is inexpensive and easily installed on the stabilizer bar 12. As can be seen, the ends may still be spaced, such that a complete circle is not formed. However, the ends 26 are now spaced by a small distance, which is much less than the diameter of exterior surface 28.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A stabilizer bar assembly for a vehicle suspension comprising:
a stabilizer bar body defining a lateral axis;
at least one bushing mounted on said stabilizer bar body; and
at least one crimp ring mounted on said stabilizer bar body adjacent to said at least one bushing to prevent relative axial movement between said at least one bushing and said stabilizer bar body in a direction along said lateral axis.

2. The stabilizer bar assembly according to claim 1 wherein said at least one crimp ring is installed on said stabilizer bar body in a first configuration and is deformed into a second configuration such that said at least one crimp ring is permanently retained on said stabilizer bar body.

3. The stabilizer bar assembly according to claim 2 wherein said first configuration comprises a C-shape and said second configuration comprises a generally circular shape.

4. The stabilizer bar assembly according to claim 1 wherein said at least one crimp ring comprises a plastically deformed body that substantially surrounds an outer surface of said stabilizer bar body.

5. The stabilizer bar assembly according to claim 1 wherein said at least one crimp ring is moved in a direction transverse to said lateral axis when inserted onto said stabilizer bar body.

6. The stabilizer bar assembly according to claim 1 wherein said at least one bushing is adapted for mounting to a vehicle structure.

7. A vehicle suspension comprising:
a stabilizer bar extending in a lateral direction between laterally spaced suspension components;
at least one bushing mounted to said stabilizer bar for attachment to a vehicle structure; and
at least one crimp ring mounted on said stabilizer bar adjacent to said at least one bushing, said at least one crimp ring preventing relative axial movement in said lateral direction between said stabilizer bar and said at least one bushing.

8. The vehicle suspension according to claim 7 wherein the laterally spaced suspension components comprise left and right control arms.

9. The vehicle suspension according to claim 7 wherein said at least one crimp ring is configurable between an initial configuration and a subsequent configuration, said initial configuration comprising a C-shape and said subsequent configuration comprising a generally circular shape.

10. The vehicle suspension according to claim 9 wherein said at least one crimp ring includes a plastically deformed portion when configured in said subsequent configuration.

11. The vehicle suspension according to claim 11 wherein said at least one crimp ring is moved in a direction transverse to said lateral direction when installed on said stabilizer bar.

12. A method of assembling a vehicle suspension comprising the steps of:
(a) installing at least one bushing on a stabilizer bar that defines an axis extending generally along a length of the stabilizer bar; and
(b) crimping at least one crimp ring around the stabilizer bar adjacent to the at least one bushing to prevent relative axial movement between the stabilizer bar and the at least one bushing in a direction along the axis.

13. The method according to claim 12 wherein step (b) comprises deforming the at least one crimp ring from a C-shaped configuration to a generally circular shaped configuration to permanently attach the at least one crimp ring to the stabilizer bar.

14. The method according to claim 12 wherein the at least one crimp ring has an initial shape and a subsequent shape and wherein step (b) includes
(b1) installing the at least one crimp ring in the initial shape on the stabilizer bar; and
(b2) deforming the at least one crimp ring into the subsequent shape after performing step (b1).

15. The method according to claim 14 wherein step (b1) includes moving the at least one crimp ring in a direction transverse to the axis.

16. The method according to claim 15 wherein the initial shape comprises a C-shape having first and second distal ends that are spaced apart from each other and wherein step (b2) includes moving the first and second distal ends towards each other such that the at least one crimp ring generally surrounds an exterior surface of the stabilizer bar.
